(19) United States
(12) Patent Application Publication
(10) Pub. No.: US 2011/0040869 A1
(43) Pub. Date: Feb. 17, 2011

(54) ELECTRONIC DEVICE WITH WEBSITE INFORMATION

(75) Inventors: TIEN-PING LIU, Tu-Cheng (TW); CHIA-PENG WANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/611,145

(22) Filed: Nov. 3, 2009

(30) Foreign Application Priority Data
Aug. 12, 2009 (CN) 200910305533.X

(51) Int. Cl. G06F 15/173

(52) U.S. Cl. 709/224

(57) ABSTRACT

An electronic device is capable of communicating with at least one website via a network. The electronic device includes a storage module, an executing module, an integrating module, and a display module. The executing module is capable of retrieving information from the at least one website via the at least one webpage address. The integrating module is capable of determining positions where the information would be displayed in the electronic device. The display module is capable of displaying the information in the determined positions.

### BACKGROUND

1. Technical Field

The present disclosure relates to electronic devices, and particularly to an electronic device capable of displaying website information from website hosts.

2. Description of Related Art

Currently, many electronic devices, such as digital photo frames, electronic clocks and so on are placed in houses in different locations. Usually, each electronic device serves a unique purpose resulting in a different device in the home for each desired purpose.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device communicating with a website host via a network, in accordance with an embodiment.

FIG. 2 is a block diagram of the electronic device of the embodiment of FIG. 1.

FIG. 3 is a block diagram of a storage module of the embodiment of FIG. 2.

FIG. 4 is a flow chart of a method for the electronic device of the embodiment of FIG. 2 for getting information from the website hosts.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

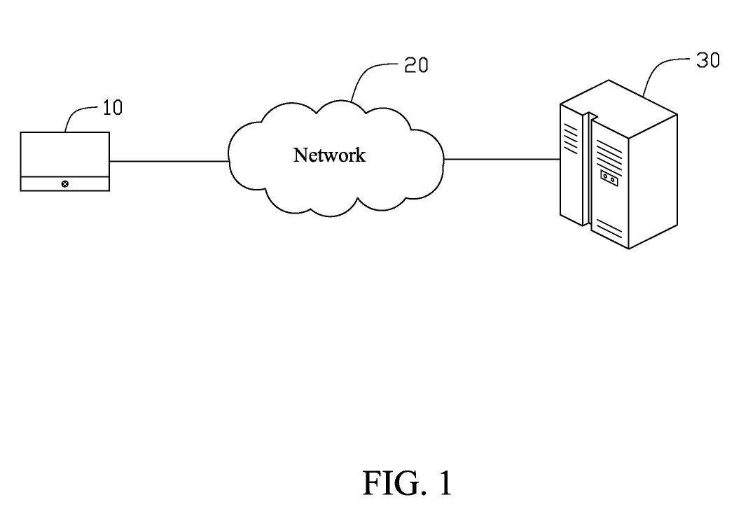

FIG. 1 illustrates an electronic device 10 in accordance with an embodiment communicating with a website host 30 via a network 20. In one embodiment, the website host 30 may be a server computer, a desktop computer, or a notebook computer, for example. The electronic device 10 may be a digital photo frame, an electronic billboard, an electronic clock, or a computer, etc., for example.

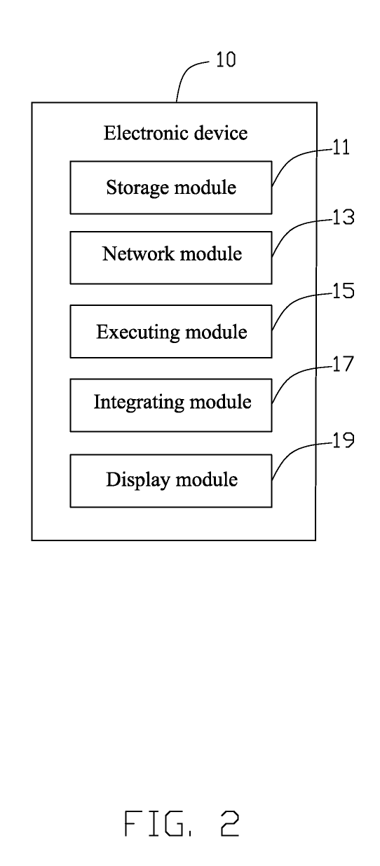

Referring also to FIG. 2, the electronic device 10 includes a storage module 11, a network module 13, an executing module 15, an integrating module 17, and a display module 19.

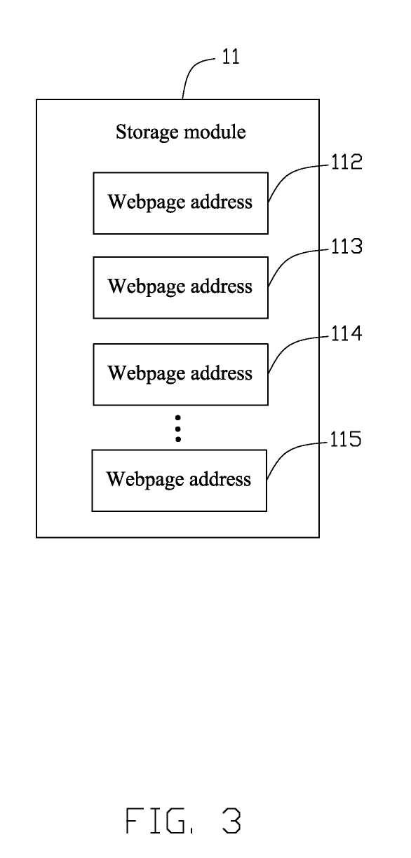

Referring also to FIG. 3, the storage module 11 stores a plurality of webpage addresses 112, 113, 114, 115 (shown in FIG. 2). Each webpage corresponding to one of the webpage addresses 112, 113, 114, 115, can contain desired information or media such as images etc. In one embodiment, the webpage corresponding to the webpage address 112 has time zone, internet time, longitude, and latitude of the location of the electronic device 10. The webpage corresponding to the webpage address 113 has weather information of where the electronic device 10 is located. The webpage corresponding to the webpage address 114 has local news. Another webpage corresponding to the webpage address 115 has information for shops, entertainment, and hotels of where the electronic device 10 is located.

The network module 13 is capable of connecting the electronic device 10 to a network 20.

The executing module 15 is capable of handling, such as editing, adding and so on, the webpage addresses to the storage module 11, and retrieving information from the website host 30 according to the webpage addresses 112, 113, 114, 115.

The integrating module 17 is capable of determining positions and modes in which the information retrieved by the executing module 15 is displayed in the electronic device 10.

The display module 19 is capable of display the information in different positions determined by the integrating module 17.

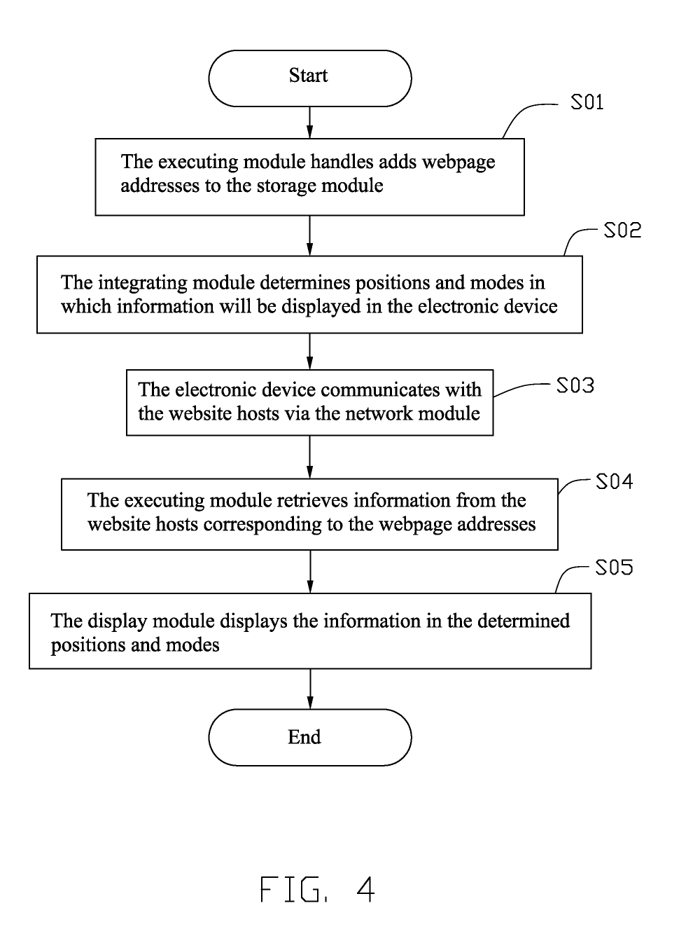

FIG. 4 illustrates a flow chart of a method for the electronic device 10 displaying the information in accordance with one embodiment.

In block S01, the executing module 15 handles the webpage addresses 112, 113, 114, 115 to the storage module 11.

In block S02, the integrating module 17 determines positions and modes in which the information according to the webpage address 112, 113, 114, 115 will be displayed in the electronic device 10.

In block S03, the electronic device 10 communicates with the website host 30 via the network 20.

In block S04, the executing module 15 retrieves the information from the website host 30 via webpage addresses 112, 113, 114, 115.

In block S05, the display module 19 displays the information in the electronic device 10 in the determined positions and under modes.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. An electronic device capable of communicating with at least one website host via a network, the electronic device comprising:
a storage module storing at least one webpage address corresponding to the at least one website host;
an executing module capable of retrieving information from the at least one website host;
an integrating module capable of determining positions where the information would be displayed in the electronic device; and
a display module capable of displaying the information in the determined positions.

2. The electronic device of claim 1, further comprising a network module capable of communicating the electronic device with the network.

3. The electronic device of claim 1, wherein the information comprises at least one of time zone, internet time, a longitude and a latitude of the location of the electronic device, and weather information of a city where the electronic device is located.

4. The electronic device of claim 1, wherein the information comprises local news.

5. The electronic device of claim 1, wherein the information comprises information of at least one of shops, marketplaces, and hotels.

6. The electronic device of claim 1, wherein the electronic device is one of a digital photo frame, an electronic billboard, and an electronic clock.

7. The electronic device of claim 1, wherein the integrating module is further capable of setting modes in which the information is displayed.

8. The electronic device of claim 7, wherein one of the modes is a graphics mode.

9. The electronic device of claim 1, further comprising an executing module capable of handling the at least one webpage address.

10. An electronic device capable of communicating with at least one website host via a network, the electronic device comprising:
a storage module storing at least one webpage address according to the at least one website host;
an executing module capable of retrieving information from the at least one website host;
an integrating module capable of determining modes in which the information is displayed in the electronic device; and
a display module capable of displaying the information in the determined modes.

11. The electronic device of claim 10, further comprising a network module capable of communicating the electronic device with the network.

12. The electronic device of claim 10, wherein the information comprises at least one of time zone, internet time, a longitude and a latitude of the location of the electronic device, and weather information of a city where the electronic device is located.

13. The electronic device of claim 10, wherein the information comprises local news.

14. The electronic device of claim 10, wherein the information comprises information of at least one of shops, marketplaces, and hotels.

15. The electronic device of claim 10, wherein the electronic device is one of a digital photo frame, an electronic billboard, and an electronic clock.

16. The electronic device of claim 10, wherein the integrating module is further capable of determining positions where the information is displayed.

17. The electronic device of claim 10, wherein one of the modes is a graphics mode.

18. The electronic device of claim 10, wherein the executing module is further capable of handling the at least one webpage address.
